(19) United States
(12) Patent Application Publication
(10) Pub. No.: US 2021/0045356 A1
(43) Pub. Date: Feb. 18, 2021

(54) PET TRACTION DEVICE

(71) Applicant: Shenzhen Zhongbang Global Industrial Co., Ltd., Shenzhen (CN)

(72) Inventor: Dezhong ZHANG, Shenzhen (CN)

(21) Appl. No.: 16/725,714

(22) Filed: Dec. 23, 2019

(30) Foreign Application Priority Data
Aug. 12, 2019 (CN) 201910738592.X

(51) Int. Cl. A01K 27/00; B65H 75/44

(52) U.S. Cl. CPC A01K 27/004; B65H 75/4442

(57) ABSTRACT

A kind of pet traction device, which relates to the field of traction devices. This includes: the first upper casing; the first lower casing integrally processed with the first upper casing; the second upper casing; the second lower casing integrally processed with the second upper casing; the first upper casing and the second upper casing are relatively fixed, and the first lower casing and the second lower casing are relatively fixed; button component and rotary fixing component mounted inside the first lower casing and the second lower casing; a traction leash entry and exit mechanism mounted on the sides of the first lower casing and the second lower casing. This provides a kind of pet traction device, which can effectively reduce the occurrence of damage, minimize the probability of leash breakage, improve the using quality of the user, and increase the service life of products.

### TECHNICAL FIELDS

The invention relates to the technical field of traction devices, which involves a kind of pet traction device.

### BACKGROUND TECHNOLOGY

With the continuous improvement of people's living standards and the constant development of the national economy, people's quality of life is increasingly high. Many families will raise pets like cats and dogs, and especially many elderly people living alone prefer pets, which spend time with them and play a role of companionship. However, after all, pets are animals different from human beings. They are naturally active, and when they are irritated and in unstable mood, they will run into children or adults and cause harm to people. To this end, many owners will make traction leashes for pets to prevent them from damaging people or losing.

Currently, existing pet leashes or tractors have the following problems:

1. The leash is easy to break when the pet is suddenly running or active, and it is easy to break and unsafe.

2. The leash is easy to tie, which makes the leash difficult to recover.

3. The leash recycling mechanism is easy to fail, so that the leash can not be recycled.

4. The existing pet tractor is too bulk and too heavy to carry.

5. The existing pet tractor can not effectively lock the leash, and the leash will still be pulled out in the locked state, as the structure is not robust enough.

Invention Content

In order to solve the above problems of the existing pet leash and tractor, the present invention provides a pet traction device, which can effectively reduce the occurrence of damage, minimize the probability of leash breakage, improve the using quality of the user, and increase the service life.

The technical solution adopted by the present invention to solve the technical problem is as follows:

A pet traction device of the present invention includes:

The first upper casing;

The first lower casing integrally processed with the first upper casing, wherein the first lower casing is provided with the third fixing column, the second semi-arc opening, the fourth fixing column, the thirteenth connecting column, the fourth limiting column, the fifth limiting column, the sixth limiting column, the fourteenth connecting column, the third limit ring, the second traction leash exit mechanism mounting groove, the fifteenth connecting column, the sixteenth connecting column, the seventeenth connecting column, the first fixing ring, the second fixing ring, the third fixing ring, center column, the second limiting plate, and the eighteenth connecting column;

The second upper casing;

The second lower casing integrally processed with the second upper casing, wherein the second lower casing is provided with the first fixing column, the fourth connecting column, the second fixing column, the first limiting column, the second limiting column, the third limiting column, traction leash fixing column, the first limit ring, the fifth connecting column, the second limit ring, the first traction leash exit mechanism mounting groove, the sixth connecting column, the seventh connecting column, the eighth connecting column, fixed mounting shaft, the first limiting plate, the ninth connecting column, and the first semi-arc opening;

The first fixing column, the fourth connecting column, the second fixing column, the fifth connecting column, the sixth connecting column, the seventh connecting column, the eighth connecting column, and the ninth connecting column are respectively connected to the third fixing column, the thirteenth connecting column, the fourth fixing column, the fourteenth connecting column, the fifteenth connecting column, the sixteenth connecting column, the seventeenth connecting column and the eighteenth connecting column; the first semi-arc opening is opposite to the second semi-arc opening, and the first semi-arc opening and the second semi-arc opening constitute an opening; the first traction leash exit mechanism mounting groove is opposite to the second traction leash exit mechanism mounting groove, and the first traction leash exit mechanism mounting groove and the second traction leash exit mechanism mounting groove constitute a traction leash outlet mechanism mounting groove;

The first upper casing and the second upper casing are relatively fixed, and the first lower casing and the second lower casing are relatively fixed;

Button component and rotary fixing component mounted inside the first lower casing and the second lower casing, wherein, the button component comprising: button, sleeve, spring, expansion fastener, rotating fastener, one end of the spring is fixed on the expansion fastener, and the other end of the spring is fixed on the sleeve; the sleeve is set at the lower end of the button, and the rotating fastener is installed inside the button and the sleeve; the upper end of the expansion fastener is mounted inside the rotating fastener, and the button is installed in an opening composed of the first semi-arc opening and the second semi-arc opening;

A traction leash entry and exit mechanism mounted on the sides of the first lower casing and the second lower casing.

It further includes the first fixing clip fixed to the side edges of the first lower casing and the second lower casing, the second fixing clip fixed to the lower edges of the first lower casing and the second lower casing, and the first surface groove set on the surface of the first lower casing and the second surface groove set on the second lower casing surface.

Further, the first upper casing is internally provided with the tenth connecting column, the eleventh connecting column, the twelfth connecting column and the second opening edge;

The second upper casing is internally provided with the first connecting column, the second connecting column, the third connecting column, and the first opening edge;

The first connecting column, the second connecting column and the third connecting column are respectively connected to the tenth connecting column, the eleventh connecting column and the twelfth connecting column, and the first opening edge is opposite to the second opening edge.

Further, the button is hollow inside, the upper surface of the button is a sloped structure, and the lower end side of the button is provided with six rectangular limiting columns, and the lower end surface of the button is provided with six first waveform protruding structures, and the surface of the first waveform protruding structure is the first incline;

The upper end of the expansion fastener is provided with a circular column, the lower end of which is provided with a mounting seat, and the first fixing ring and the second fixing ring are set on the upper surface of the mounting seat; the first fixing block, the first waveform fixing block, the second fixing block and the second waveform fixing block are set on the lower surface of the mounting seat; and the first fixing block and the first waveform fixing block are located on the left side, and the second waveform fixing block and the second fixing block are on the right side;

The rotating fastener is provided with a small cylinder at the upper end, a large cylinder at the lower end, and an annular convex structure at the lower end of the large cylinder; three second waveform protruding structures and three third waveform protruding structures are set at the upper end of the large cylinder; three second convex structures are set on the outer wall of the large cylinder, and the upper edge of the second convex structure is provided with the third incline; the circular column in the expansion fastener is installed in the large cylinder, and the circular column and the large cylinder are in an interference fit; and the upper end of the circular column bears against the lower end of the small cylinder, and the small cylinder extends into the interior of the button; Three second waveform protruding structures and three third waveform protruding structures respectively cooperate with the six first waveform protruding structures at the lower end of the button, that is, the second waveform protruding structure and an adjacent one of the third waveform protruding structures form a groove corresponding to the first waveform protruding structure, wherein after the button and the rotating fastener are installed, three non-adjacent ones of six rectangular limiting columns on the button vertically correspond to three second convex structures respectively.

Further, the sleeve is externally provided with the first connecting block and the second connecting block; the first connecting block is respectively connected to the first fixing column and the third fixing column by screws, and the second connecting block is connected to the second fixing column and the fourth fixing column respectively by screws. The sleeve is internally provided with six first convex structures, and a rectangular groove is formed between each two first convex structures for a total of three rectangular grooves, and the second incline is set at a lower end of each of the first convex structures; the sleeve is set on the button, the rotating fastener, and the outer part of the circular column; the upper end of the sleeve is set at the lower end of the button, and the three rectangles corresponding to the three second convex structures in the six rectangular limiting columns at the lower end of the button respectively; the limiting columns are one-to-one correspondingly mounted in three rectangular grooves, and the three second convex structures are respectively mounted in three rectangular grooves;

One end of the spring is fixed in the first fixing ring and the second fixing ring of the expansion fastener, and the other end of the spring is fixed on the outer cylinder wall of the sleeve;

The first limiting column and the third limiting column are respectively mounted on opposite sides of one end of the mounting seat, and the fourth limiting column and the sixth limiting column are respectively installed on opposite sides of the other end of the mounting seat, going through the first limiting column, the third limiting column, the fourth limiting column and the sixth limiting column to limit the mounting seat; the fifth limiting column is mounted on one side of the first fixing block, and the second limiting column is mounted on one side of the second fixing blocking, limiting the first fixing block through the fifth limiting column, and limiting the second fixing block through the second limiting column;

The first incline of the surfaces of the six first waveform protruding structure surfaces is respectively matched with the three inclines of three second waveform protruding structure surfaces and the incline of three third waveform protruding structure surfaces; and the third incline of the upper edge of the second convex structure corresponds to the rectangular limiting column instead of the first incline.

Further, the rotary fixing component includes the first rotating wheel and the second rotating wheel, and the first rotating wheel and the second rotating wheel are connected by a connecting cylinder, and the wheel disc rim of the first rotating wheel is provided with 24 tooth structures. Each of the two tooth structures is provided with a fixing groove, and a lightweight structure is arranged on the wheel disc of the first rotating wheel, and the lightweight outer ring is connected with the inner ring of 24 tooth structures; the lightweight inner ring is connected to the fourth fixing ring, and the fifth fixing ring is located on the inner ring of the fourth fixing ring; the fifth fixing ring is fixed on the wheel disc of the first rotating wheel, the sixth fixing ring is located in the inner ring of the fifth fixing ring, and the sixth fixing ring is fixed on the wheel disc of the first rotating wheel; the center ring is located on the inner ring of the sixth fixing ring, and the center ring is fixed on the wheel disc of the first rotating wheel, and the fixing hole of the traction leash is set on the outer ring of the lightweight structure;

The lightweight structure of the first rotating wheel is limited by the second limit ring, and the wheel disc of the first rotating wheel is limited by the first limit ring; The lightweight structure of the second rotating wheel is limited by the third limit ring;

The center ring of the first rotating wheel is sleeved on the fixed mounting shaft of the second lower casing, while the center ring of the second rotating wheel is set on the center column of the first lower casing, and the fourth fixing ring of the second rotating wheel is mounted on the first fixing ring outer ring; the fifth fixing ring of the second rotating wheel is installed in the annular groove between the first fixing ring and the second fixing ring; and the sixth fixing ring of the second rotating wheel is mounted on the second fixing ring inside the annular groove between the third fixing ring.

Further, the traction leash entry and exit mechanism comprises the body, the ring structure, wherein the inlet and outlet inclines, the traction leash inlet and outlet. The traction leash inlet and outlet are arranged in the middle of the body; the inlet and outlet inclines are arranged at the inlet and outlet edges of the traction leash; the ring structure is arranged at the outer edge of the body, and the ring structure is installed in the second traction leash exit mechanism mounting groove to complete the connection between the traction leash inlet and outlet mechanism and the casing; and the traction leash entry and exit mechanism is mounted on the traction leash outlet mechanism composed of the first traction leash exit mechanism mounting groove and the second traction leash exit mechanism mounting groove;

The traction leash fixing column extends into the traction leash fixing hole of the first rotating wheel and the traction leash fixing hole of the second rotating wheel; the end portion is fixed by bolts, the end of the traction leash is fixed on the traction leash fixing column, and then wrapped around the connecting cylinder; and the other end of the traction leash extends out of the traction leash inlet and outlet of the traction leash entry and exit mechanism.

Further, the first limiting plate and the second limiting plate are both set in an open ring structure, and the first limiting plate and the second limiting plate are oppositely set; and the first limiting plate and the second limiting plate after buckling are installed on the outer ring of the connecting cylinder, and the first limiting plate and the second limiting plate are used for limiting the traction leash.

Beneficial effects of the invention are:

By designing the casing, the traction leash entry and exit mechanism and the rotary fixing component, the invention can effectively prevent the sudden rushing out of the pet and the unsuccessful jamming or movement of the traction leash, etc., and it has the advantages of small volume, light weight, convenient use, and quick and convenient leash retracting, etc. The traction leash will not be subject to sudden break, which can effectively prevent the pet from suddenly running away and the owner is pulled over to give the owner enough buffer space.

### DESCRIPTION OF ATTACHED FIGURES

FIG. 1 is a three-dimensional structure diagram of a pet traction device of the present invention.

FIG. 2 is a front view of a pet traction device of the present invention.

FIG. 3 is a rear view of a pet traction device of the present invention.

FIG. 4 is a left side view of a pet traction device of the present invention.

FIG. 5 is a right side view of a pet traction device of the present invention.

FIG. 6 is a top plan view of a pet traction device of the present invention.

FIG. 7 is a bottom plan view of a pet traction device of the present invention.

FIG. 8 is a structure diagram of the second upper casing and the second lower casing.

FIG. 9 is a structure diagram of the first upper casing and the first lower casing.

FIG. 10 is an internal structure diagram of a pet traction device of the present invention (the first upper casing and the first lower casing are omitted).

FIG. 11 is a three-dimensional structure diagram of a button component and a rotary fixing component.

FIG. 12 is a side structure diagram of the button component and the rotary fixing component.

FIG. 13 is a structure diagram of the button component.

FIG. 14 is a cross-sectional view of the button component along line A-A of FIG. 13;

FIG. 15 is a structure diagram of the button component (the sleeve is omitted).

FIG. 16 is a structure diagram of the button component (the sleeve and the rotating fastener are omitted).

FIG. 17 is a structure diagram of a rotating fastener.

FIG. 18 is a structure diagram of the sleeve.

FIG. 19 is a three-dimensional structure diagram of the traction leash exit mechanism.

FIG. 20 is a front view of the traction leash exit mechanism.

FIG. 21 is a rear view of the traction leash exit mechanism.

FIG. 22 is a schematic view showing the mating relationship between the first incline 8-13 and the third incline 8-52.

As shown in Figure: 1. First upper casing; 2. Second upper casing; 3. First lower casing; 4. Second lower casing; 5. First fixing clip; 6. Second fixing clip; 7. First surface groove; 8. Button component; 9. Second surface groove; 10. Traction leash entry and exit mechanism rotary fixing component, and 11. Rotary fixing component.

### SPECIFIC IMPLEMENTATION MODE

Make a detailed description of the invention by combining the attached figure.

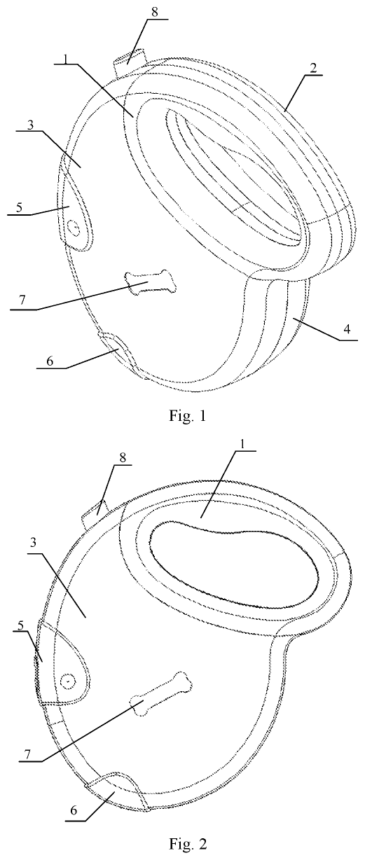

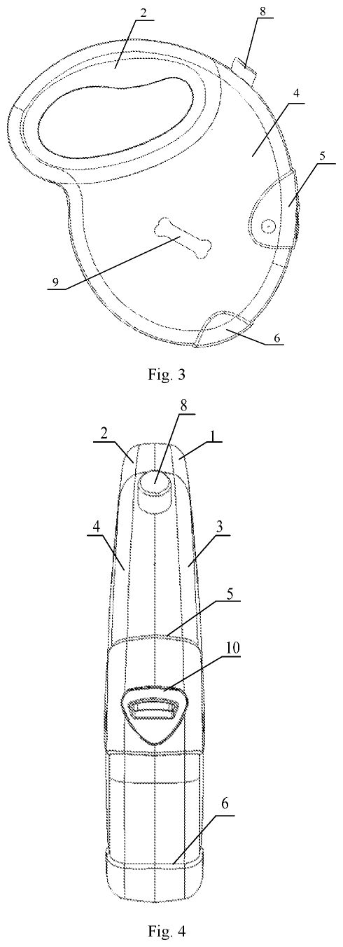

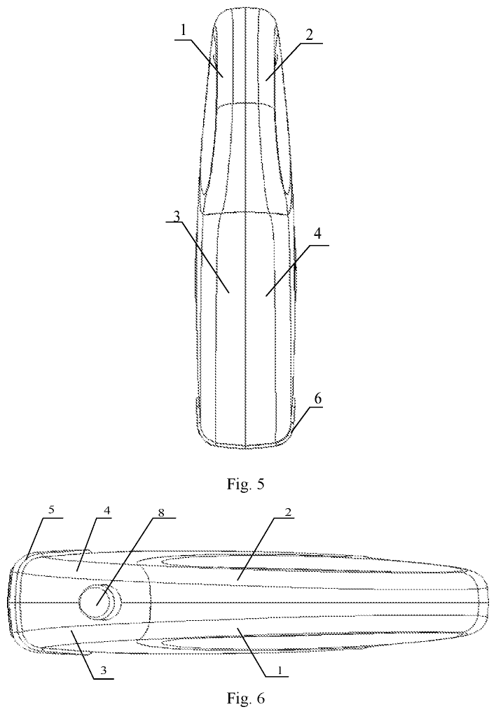

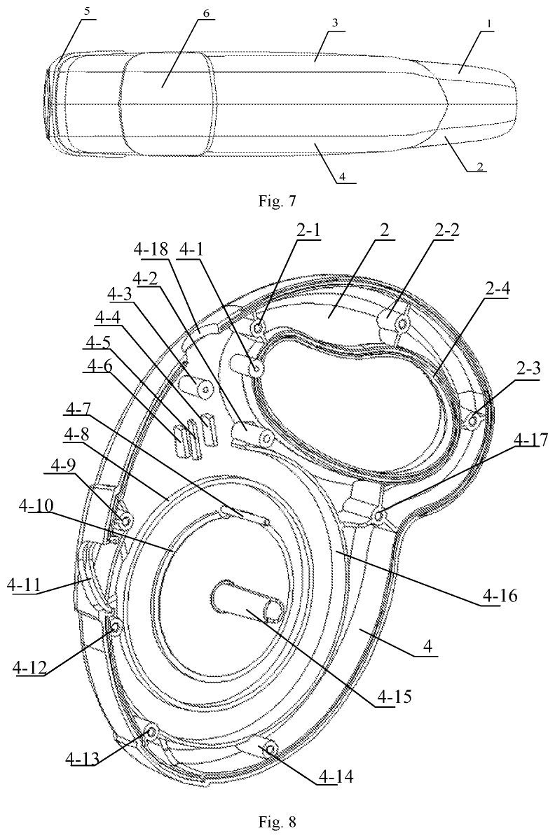

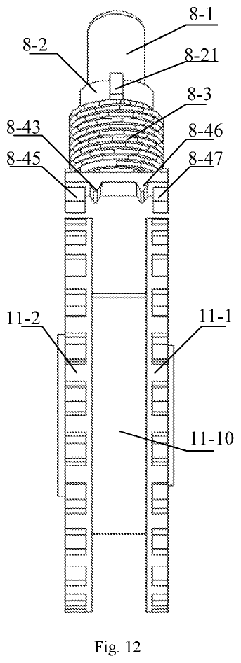

As shown in FIGS. 1 to 21, a pet traction device of the present invention mainly comprises: the first upper casing 1, the second upper casing 2, the first lower casing 3, the second lower casing 4, the first fixing clip 5, the second fixing clip 6, the first surface groove 7, button component 8, the second surface groove 9, the traction leash entry and exit mechanism, 10, and the rotary fixing component 11.

As shown in FIG. 1-7, the first upper casing 1, the second upper casing 2, the first lower casing 3, and the second lower casing 4 constitute a device casing. The first upper casing 1 and the first lower casing 3 are integrally designed, and the second upper casing 2 and the second lower casing 4 are integrally designed. The first upper casing 1 and the second upper casing 2 are oppositely fixed, and the first lower casing 3 and the second lower casing 4 are relatively fixed. The first fixing clip 5 is fixed to the side edges of the first lower casing 3 and the second lower casing 4, and the second fixing clip 6 is fixed to the lower edges of the first lower casing 3 and the second lower casing 4. The first surface groove 7 is set on the surface of the first lower casing 3, and the second surface groove 9 is set on the surface of the second lower casing 4. The button component 8 is partially mounted inside the first lower casing 3 and the second lower casing 4, and the other portion is exposed outside the first lower casing 3 and the second lower casing 4. The traction leash entry and exit mechanism 10 is mounted on the sides of the first lower casing 3 and the second lower casing 4. The rotary fixing component 11 is mounted inside the first lower casing 3 and the second lower casing 4.

The internal structure of the second upper casing 2 and the second lower casing 4 is as shown in FIG. 8. The second upper casing 2 is internally provided with the first connecting column 2-1, the second connecting column 2-2, and the third connecting column 2-3, and the first opening edge 2-4.

The second lower casing 4 is internally provided with the first fixing column 4-1, the fourth connecting column 4-2, the second fixing column 4-3, the first limiting column 4-4, and the second limiting column 4-5, the third limiting column 4-6, the traction leash fixing column 4-7, the first limit ring 4-8, the fifth connecting column 4-9, the second limit ring 4-10, the first traction leash exit mechanism mounting groove 4-11, the sixth connecting column 4-12, the seventh connecting column 4-13, the eighth connecting column 4-14, fixed mounting shaft 4-15, the first limiting plate 4-16, the ninth connecting column 4 -17, and the first semi-arc opening 4-18.

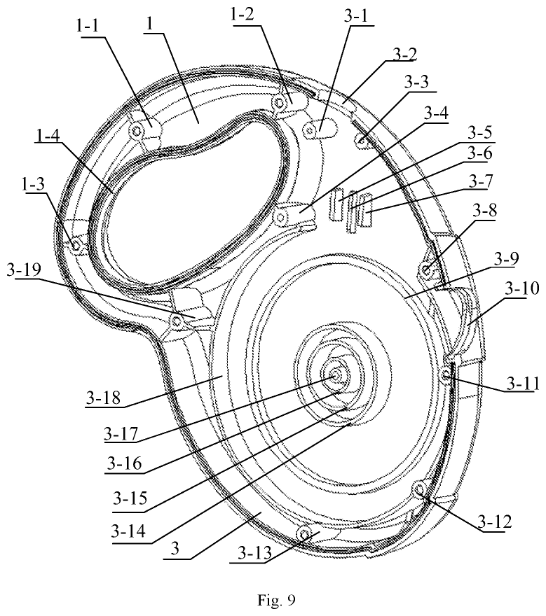

The internal structure of the first upper casing 1 and the first lower casing 3 is as shown in FIG. 9, and the first upper casing 1 is internally provided with the tenth connecting columns 1-1, the eleventh connecting columns 1-2, the twelfth connecting columns 1-3, and the second opening edges 1-4.

The first lower casing 3 is internally provided with the third fixing column 3-1, the second semi-arc opening 3-2, the fourth fixing column 3-3, the thirteenth connecting column 3-4, and the fourth limiting column 3-5. The fifth limiting column 3-6, the sixth limiting column 3-7, the fourteenth connecting column 3-8, the third limit ring 3-9, the second traction leash exit mechanism mounting groove 3-10, the fifteenth connecting column 3-11, the sixteenth connecting column 3-12, the seventeenth connecting column 3-13, the first fixing ring 3-14, the second fixing ring 3-15, and the third fixing ring 3-16, the center column 3-17, the second limiting plate 3-18, and the eighteenth connecting column 3-19.

The casing composed of the first upper casing 1 and the first lower casing 3 is fixedly connected to the casing composed of the second upper casing 2 and the second lower casing 4. Namely: The first connecting column 2-1, the second connecting column 2-2, and the third connecting column 2-3 inside the second upper casing 2 are respectively connected to the tenth connecting column 1-1, the eleventh connecting column 1-2, and the twelfth connecting column 1-3 inside the first upper casing 1 by screws. The first opening edge 2-4 is set opposite to the second opening edge 1-4.

The first fixing column 4-1, the fourth connecting column 4-2, the second fixing column 4-3, the fifth connecting column 4-9, the sixth connecting column 4-12, and the seventh connection, the seventh connecting column 4-13, the eighth connecting column 4-14, the ninth connecting column 4-17 inside the second lower casing 4 are respectively connected to the third fixing column 3-1, the thirteenth connecting column 3-4, and the fourth fixing column 3-3, the fourteenth connecting column 3-8, the fifteenth connecting column 3-11, the sixteenth connecting column 3-12, the seventeenth connecting column 3-13, and the eighteenth connecting column 3-19 inside the first lower casing 3 be screws. The first semi-arc opening 4-18 is set opposite to the second semi-arc opening 3-2, and the first semi-arc opening 4-18 and the second semi-arc opening 3-2 constitute an opening, and the button 8-1 of the button component 8 is installed in this opening. The first traction leash exit mechanism mounting groove 4-11 and the second traction leash exit mechanism mounting groove 3-10 are oppositely set. The first traction leash exit mechanism mounting groove 4-11 and the second traction leash exit mechanism mounting groove 3-10 constitute a traction leash exit mechanism mounting groove, and the traction leash entry and exit mechanism 10 is installed in the traction leash exit mechanism mounting groove.

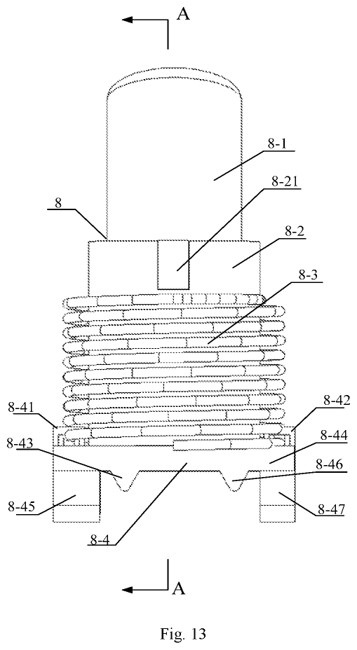

The structure of the button component 8 is as shown in FIG. 13-18 The button component 8 mainly includes: button 8-1, sleeve 8-2, spring 8-3, expansion fastener 8-4, and rotating fastener 8-5. One end of the spring 8-3 is fixed to the expansion fastener 8-4, and the other end of the spring 8-3 is fixed to the sleeve 8-2. The sleeve 8-2 is placed at the lower end of the button 8-1. The rotating fastener 8-5 is mounted inside the button 8-1 and the sleeve 8-2. The upper end of the expansion fastener 8-4 is installed inside the rotating fastener 8-5.

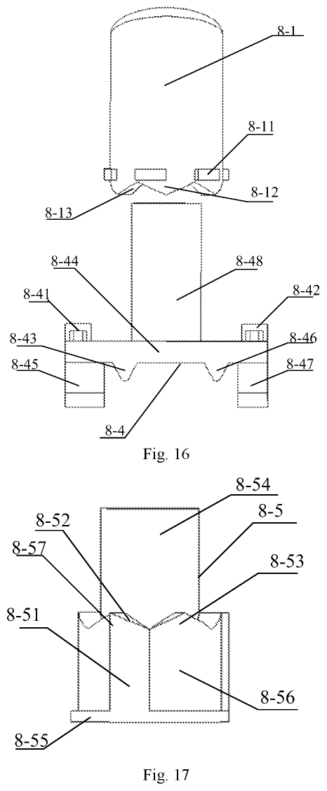

As shown in FIG. 15 and FIG. 16, the button 8-1 is hollow inside. The upper surface of the button 8-1 is a sloped structure, the lower end side of the button 8-1 is provided with six rectangular limiting columns 8-11, and the lower end of the button 8-1 is provided with six first waveform protruding structures 8-12, and the surface of the first waveform protruding structure 8-12 is the first incline 8-13.

As shown in FIG. 16, the upper end of the expansion fastener 8-4 is provided with a circular column 8-48, and the lower end of the circular column 8-48 is provided with a mounting seat 8-44; the mounting seat 8-44 is provided with the first fixing ring 8-41 and the second fixing ring 8-42; the first fixing block 8-45, the first waveform fixing block 8-43, the second waveform fixing block 8-46, and the fixing block 8-47, and the second surface are set on the lower surface of the mounting seat 8-44; and the first fixing block 8-45 and the first waveform fixing block 8-43 are a group on the left side, and the second waveform fixing block 8-46 and the second fixing block 8-47 is a group on the right side.

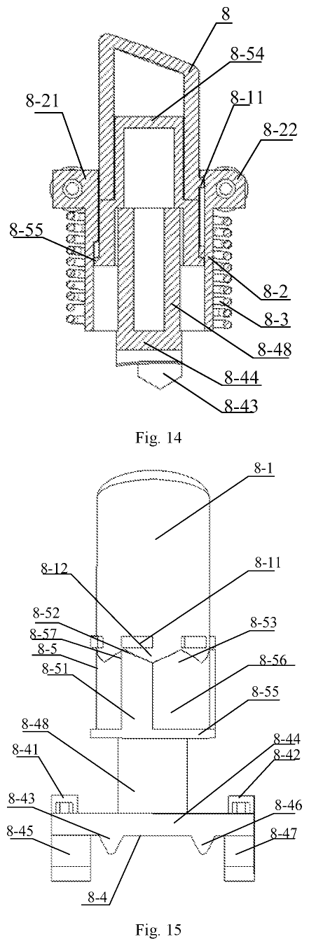

As shown in FIG. 17, the upper end of the rotating fastener 8-5 is provided with a small cylinder 8-54, and the lower end is provided with a large cylinder 8-56; the lower end of the large cylinder 8-56 is provided with an annular convex structure 8-55, and the upper end of the large cylinder 8-56 is provided with three second waveform protruding structures 8-53 and three third waveform protruding structures 8-57; and three second convex structures 8-51 are set on the outer wall of the large cylinder 8-56, and the upper edge of the second convex structure 8-51 is provided with the third incline 8-52. The circular column 8-48 in the expansion fastener 8-4 is mounted in the large cylinder 8-56, and the cylinder 8-48 is in an interference fit with the large cylinder 8-56, while the upper end of the circular column 8-48 is against the lower end of the small cylinder 8-54, as shown in FIG. 14. The small cylinder 8-54 extends into the interior of the button 8-1. The three second waveform protruding structures 8-53 and the three third waveform protruding structures 8-57 respectively cooperate with the six first waveform protruding structures 8-12 at the lower end of the button 8-1, that is, a groove is formed between one second waveform protruding structure 8-53 and an adjacent third waveform protruding structure 8-57, and the first waveform protruding structure 8-12 is correspondingly mounted in the groove. After the button 8-1 and the rotating fastener 8-5 are installed, three of the six rectangular limiting columns 8-11 on the button 8-1 (three of the six non-adjacent) respectively correspond to three second convex structures 8-51, as shown in FIG. 15.

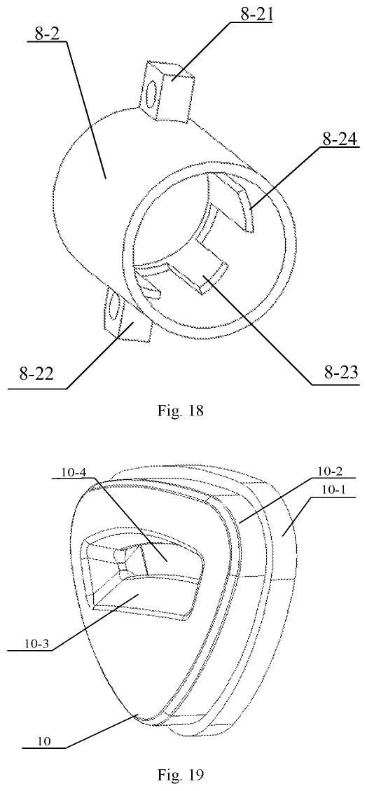

As shown in FIG. 18, the sleeve 8-2 is generally cylindrical, and the sleeve 8-2 is externally provided with the first connecting block 8-21 and the second connecting block 8-22; and the first connecting block 8-21 is respectively connected to the first fixing column 4-1 and the third fixing column 3-1 by screws, and the second connecting block 8-22 is respectively connected to the second fixing column 4-3 and the fourth fixing column 3-3 by screws. The sleeve 8-2 is internally provided with six first convex structures 8-23, and a rectangular groove is formed between each two first convex structures 8-23 with a total of three rectangular grooves. The second incline 8-24 is set at a lower end of each of the first convex structures 8-23. The sleeve 8-2 is fitted over the button 8-1, the rotating fastener 8-5, and the circular column 8-48. Specifically: The upper end of the sleeve 8-2 is set at the lower end of the button 8-1, and the three of the six rectangular limiting columns 8-11 at the lower end of the button 8-1 (are respectively corresponding to the three second convex structures 8-51—the three rectangular limiting columns 8-11 structures vertically) are respectively mounted in three rectangular grooves. The three second convex structures 8-51 are respectively mounted in three rectangular grooves in.

One end of the spring 8-3 is fixed in the first fixing ring 8-41 and the second fixing ring 8-42 of the expansion fastener 8-4, and the other end of the spring 8-3 is fixed on the outer cylinder wall of the sleeve 8-2, as shown in FIG. 13.

After the button component 8 is assembled as a whole, the first limiting column 4-4 and the third limiting column 4-6 are respectively mounted on the opposite sides of one end of the mounting seat 8-44; the fourth limiting column 3-5 and the sixth limiting columns 3-7 are respectively mounted on the opposite sides of the other end of the mounting seat 8-44, limit the mounting seat 8-44 by passing through the first limiting column 4-4 and the third limiting column 4-6, the fourth limiting column 3-5 and the sixth limiting column 3-7. The fifth limiting column 3-6 is mounted on the side of the first fixing block 8-45, and the second limiting column 4-5 is mounted on the side of the second fixing block 8-47, limiting the first fixing block 8-4 through the fifth limiting column 3-6 and limiting the second fixing block 8-47 through the second limiting column 4-5.

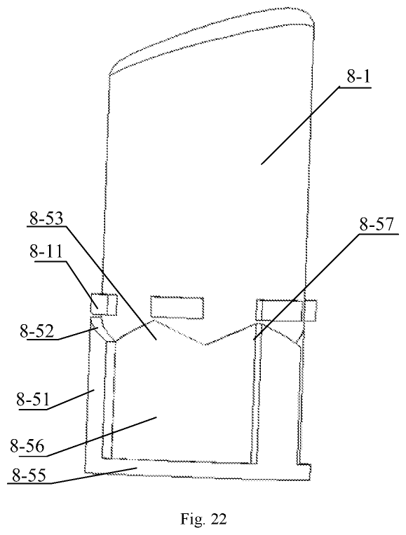

The first inclines 8-13 of the surfaces of the six first waveform protruding structures 8-12 are respectively matched with the surface inclines of the three second waveform protruding structures 8-53 and the surface inclines of the three third waveform protruding structures 8-57, respectively. As shown in FIG. 22, the third incline 8-52 of the upper edge of the second convex structure 8-51 corresponds to the rectangular limiting column 8-11 instead of the first incline 8-13.

After pressing button 8-1, the lower end of button 8-1 pushes the rotating fastener 8-5 downward, and the rotating fastener 8-5 pushes the expansion fastener 8-4 downward; the spring 8-3 is transformed from the compressed state to an extended state, and the rectangular limiting columns 8-11 and the second convex structures 8-51 slide downward along the rectangular grooves between the first convex structures 8-23 inside the sleeve 8-2. After the second convex structure 8-51 leaves the rectangular groove, the rectangular limiting column 8-11 remains in the rectangular groove, and at this time, the third incline 8 passing through the upper edge of the second convex structure 8-51 52 cooperates with the second incline 8-24 at the lower end of the first convex structure 8-23 to rotate the rotating fastener 8-5 by 30°, so that the third incline 8-52 of the upper edge of the second convex structure 8-51 is attached to the second incline 8-24 of the lower end of the first convex structure 8-23 to realize the extension and fixing of the expansion fastener 8-4.

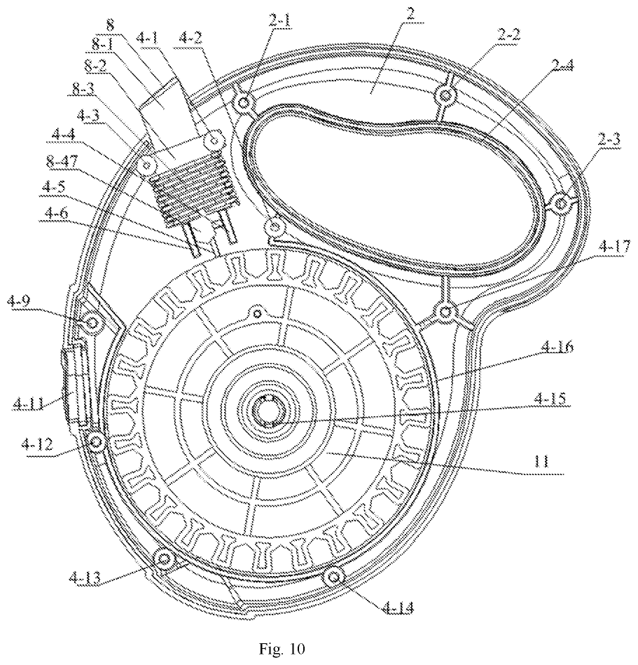

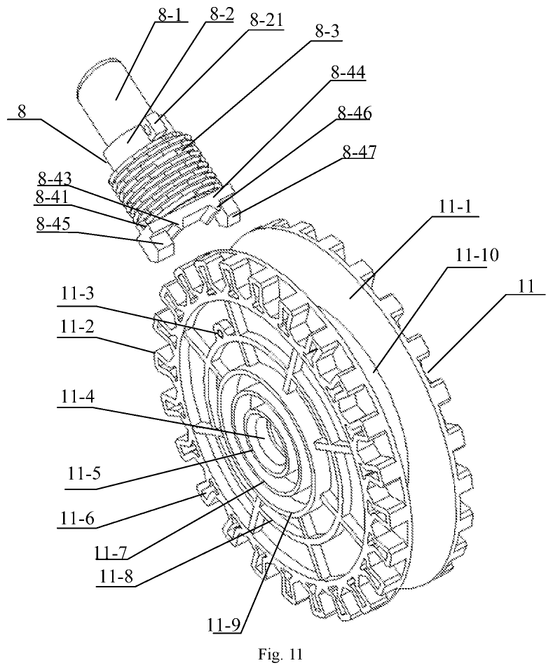

The structure of the rotary fixing component 11 is as shown in FIG. 10-12. The rotary fixing component 11 includes two rotating wheels of the same structure, namely the first rotating wheel 11-1 and the second rotating wheel 11-2. The first rotating wheel 11-1 and the second rotating wheel 11-2 are connected by a connecting cylinder 11-10. The first rotating wheel 11-1 therein will be described in detail below. As shown in FIG. 11, the wheel disc rim of the first rotating wheel 11-1 is provided with 24 tooth structures 11-6, and between each two tooth structures 11-6 is a fixing groove. A lightweight structure 11-8 is set on the wheel disc of the first rotating wheel 11-1, and the outer ring of the lightweight structure 11-8 is connected to the inner ring of the 24 tooth structures 11-6, and the inner ring of the lightweight structure 11-8 is connected to the fourth fixing ring 11-9. The fifth fixing ring 11-7 is located in the inner ring of the fourth fixing ring 11-9, and the fifth fixing ring 11-7 is fixed on the wheel disc of the first rotating wheel 11-1; the sixth fixing ring 11-5 is located at the inner ring of the fixing ring 11-7, and the sixth fixing ring 11-5 is fixed on the wheel disc of the first rotating wheel 11-1; and the center ring 11-4 is located in the inner ring of the sixth fixing ring 11-5, and the center ring 11 -4 is fixed to the wheel disc of the first rotating wheel 11-1. The traction leash fixing holes 11-3 are provided on the outer ring of the lightweight structure 11-8.

The lightweight structure 11-8 of the first rotating wheel 11-1 is limited by the second limit ring 4-10, and the rotating wheel disc of the first rotating wheel 11-1 is limited by the first limit ring 4-8; the lightweight structure 11-8 of the second rotating wheel 11-2 is limited by the third limit ring 3-9.

The rotary fixing component 11 is mounted inside the first lower casing 3 and the second lower casing 4. Specifically: the center ring 11-4 of the first rotating wheel 11-1 is fitted over the fixed mounting shaft 4-15 of the second lower casing 4, while the center ring 11-4 of the second rotating wheel 11-2 is set on the center column 3-17 of the first lower casing 3; the fourth fixing ring 11-9 of the second rotating wheel 11-2 is mounted on the outer ring of the first fixing ring 3-14, and the fifth fixing ring 11-7 of the second rotating wheel 11-2 is installed in the annular groove between the first fixing ring 3-14 and the second fixing ring 3-15; the sixth fixing ring 11-5 of the second rotating wheel 11-2 is mounted on the annular groove between the second fixing ring 3-15 and the third fixing ring 3-16.

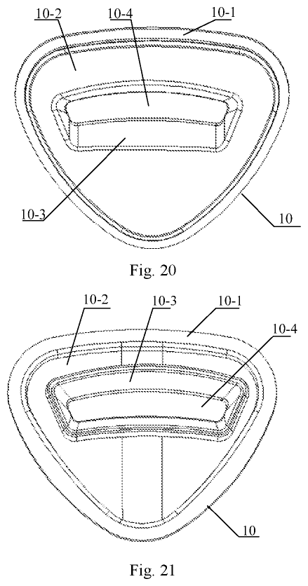

The structure of the traction leash entry and exit mechanism 10 is as shown in FIG. 19-21. The traction leash entry and exit mechanism 10 mainly includes the body 10-2, the ring structure 10-1, the inlet and outlet incline 10-3, and the traction leash inlet and outlet 10-4. The traction leash inlet and outlet 10-4 is set in the middle of the body 10-2, and the inlet and outlet incline 10-3 is set at the edge of the traction leash inlet and outlet 10-4. The ring structure 10-1 is set at the outer edge of the body 10-2, and the ring structure 10-1 is installed in 4-11 and 3-10 to connect the traction leash entry and exit mechanism 10 to the casing.

The traction leash fixing column 4-7 extends into the traction leash fixing hole 11-3 of the first rotating wheel 11-1 and the traction leash fixing hole 11-3 of the second rotating wheel 11-2, and the ends are bolted. The end of the traction leash is fixed to the traction leash fixing column 4-7, and then wound on the connecting cylinder 11-10; and the other end of the traction leash extends out of the traction leash inlet and outlet 10-4 of the traction leash entry and exit mechanism 10. The traction leash cord is provided with a cushioning leash (such as a material for elastic pants) with a cushioning effect.

The first limiting plate 4-16 and the second limiting plate 3-18 are both set in an open ring structure. The first limiting plate 4-16 and the second limiting plate 3-18 are oppositely set, and the first limiting plate 4-16 and the second limiting plate 3-18 are engaged and mounted on the outer ring of the connecting cylinder 11-10. The first limiting plates 4-16 and the second limiting plates 3-18 are used to limit the traction leash.

After pressing button 8-1, the lower end of button 8-1 pushes the rotating fastener 8-5 downward, and the rotating fastener 8-5 pushes the expansion fastener 8-4 downward; the spring 8-3 is transformed from the compressed state to an extended state, and the rectangular limiting columns 8-11 and the second convex structures 8-51 slide downward along the rectangular grooves between the first convex structures 8-23 inside the sleeve 8-2. After the second convex structure 8-51 leaves the rectangular groove, the rectangular limiting column 8-11 remains in the rectangular groove, and at this time, the third incline 8 passing through the upper edge of the second convex structure 8-51 52 cooperates with the second incline 8-24 at the lower end of the first convex structure 8-23 to rotate the rotating fastener 8-5 by 30°, so that the third incline 8-52 of the upper edge of the second convex structure 8-51 is attached the second incline 8-24 of the lower end of the first convex structure 8-23 to realize the extension and fixing of the expansion fastener 8-4. At this time, the mounting seat 8-44 at the lower end of the expansion fastener 8-4 reaches the designated position, that is: the first fixing block 8-45 extends into the fixing groove of the second rotating wheel 11-2, and the first waveform fixing block 8-43 is located on one side of the wheel disc of the second rotating wheel 11-2; the second fixing block 8-47 extends into the fixing groove of the first rotating wheel 11-1, and the second waveform fixing block 8-46 is located on the side of the first rotating wheel 11-1, thereby realizing the fixing of the rotating wheel and the traction leash.

The invention adopts a one-touch switch to lock the rotating wheel for the first time of pressing, and release the rotating wheel when it is pressed again, so that it is repeatedly used. The rotating wheel rotates 30° with each press, and 60° is an opening and closing group. 360° is a circle, so it is divided into 6 groups, each group consists of an opening and a closing for reuse.

The said contents are the optimal application method of the invention. It should be pointed out that common technicians in this technical field can perform several improvements and supplements without deviating principles of this invention, and such improvements as well as supplements should also be kept within the protection scope of this invention.

1. A kind of pet traction device, its features include below:
a first upper casing;
a first lower casing integrally processed with the first upper casing, wherein the first lower casing is provided with a third fixing column, a second semi-arc opening, a fourth fixing column, a thirteenth connecting column, a fourth limiting column, a fifth limiting column, a sixth limiting column, a fourteenth connecting column, a third limit ring, a second traction leash exit mechanism mounting groove, a fifteenth connecting column, a sixteenth connecting column, a seventeenth connecting column, a first fixing ring, a second fixing ring, a third fixing ring, a center column, a second limiting plate, and an eighteenth connecting column;
a second upper casing;
a second lower casing integrally processed with the second upper casing, wherein the second lower casing is provided with a first fixing column, a fourth connecting column, a second fixing column, a first limiting column, a second limiting column, a third limiting column, a traction leash fixing column a first limit ring, a fifth connecting column, a second limit ring, a first traction leash exit mechanism mounting groove, a sixth connecting column a seventh connecting column, an eighth connecting column, a fixed mounting shaft, a first limiting plate, a ninth connecting column, and a first semi-arc opening;
the first fixing column, the fourth connecting column, the second fixing column, the fifth connecting column, the sixth connecting column, the seventh connecting column, the eighth connecting column, and the ninth connecting column are respectively connected to the third fixing column, the thirteenth connecting column, the fourth fixing column, the fourteenth connecting column, the fifteenth connecting column, the sixteenth connecting column, the seventeenth connecting column and the eighteenth connecting column; the first semi-arc opening is opposite to the second semi-arc opening, and the first semi-arc opening and the second semi-arc opening constitute an opening; the first traction leash exit mechanism mounting groove is opposite to the second traction leash exit mechanism mounting groove, and the first traction leash exit mechanism mounting groove and the second traction leash exit mechanism mounting groove constitute a traction leash outlet mechanism mounting groove;
the first upper casing and the second upper casing are relatively fixed, and the first lower casing and the second lower casing are relatively fixed;
Button a button component and a rotary fixing component mounted inside the first lower casing and the second lower casing, wherein, the button component comprising: a button, a sleeve, a spring, an expansion fastener, a rotating fastener, one end of the spring is fixed on the expansion fastener, and the other end of the spring is fixed on the sleeve; the sleeve is set at the lower end of the button, and the rotating fastener is installed inside the button and the sleeve; the upper end of the expansion fastener is mounted inside the rotating fastener, and the button is installed in an opening composed of the first semi-arc opening and the second semi-arc opening; and
a traction leash entry and exit mechanism mounted on the sides of the first lower casing and the second lower casing.

2. The pet traction device according to claim 1, including a first fixing clip fixed to the side edges of the first lower casing and the second lower casing, a second fixing clip fixed to the lower edges of the first lower casing and the second lower casing, and a first surface groove set on the surface of the first lower casing and a second surface groove set on the second lower casing surface.

3. The pet traction device according to claim 1, wherein the first upper casing is internally provided with a tenth connecting column, an eleventh connecting column, a twelfth connecting column and a second opening edge;
the second upper casing is internally provided with a first connecting column, a second connecting column, a third connecting column, and a first opening edge; and
the first connecting column, the second connecting column and the third connecting column are respectively connected to the tenth connecting column, the eleventh connecting column and the twelfth connecting column, and the first opening edge is opposite to the second opening edge.

4. The pet traction device according to claim 1, wherein the button is hollow inside, the upper surface of the button is a sloped structure, and the lower end side of the button is provided with six rectangular limiting columns, and the lower end surface of the button is provided with six first waveform protruding structures, and the surface of the first waveform protruding structure is the first incline;
the upper end of the expansion fastener is provided with a circular column, the lower end of which is provided with a mounting seat, and a first fixing ring and a second fixing ring are set on the upper surface of the mounting seat; a first fixing block, a first waveform fixing block, a second fixing block and a second waveform fixing block are set on the lower surface of the mounting seat; and the first fixing block and the first waveform fixing block are located on the left side, and the second waveform fixing block and the second fixing block are on the right side; and
the rotating fastener is provided with a small cylinder, at the upper end, a large cylinder at the lower end, and an annular convex structure at the lower end of the large cylinder; three second waveform protruding structures and three third waveform protruding structures are set at the upper end of the large cylinder; three second convex structures are set on the outer wall of the large cylinder, and the upper edge of the second convex structure is provided with a third incline; the circular column in the expansion fastener is installed in the large cylinder, and the circular column and the large cylinder are in an interference fit; and the upper end of the circular column bears against the lower end of the small cylinder, and the small cylinder, extends into the interior of the button; three second waveform protruding structures, and three third waveform protruding structures respectively cooperate with the six first waveform protruding structures at the lower end of the button, that is, the second waveform protruding structure and an adjacent one of the third waveform protruding structures form a groove corresponding to the first waveform protruding structure, wherein after the button and the rotating fastener are installed, three non-adjacent ones of six rectangular limiting columns on the button vertically correspond to three second convex structures respectively.

5. The pet traction device according to claim 4, wherein the sleeve is externally provided with a first connecting block and a second connecting block; the first connecting block is respectively connected to the first fixing column and the third fixing column by screws, and the second connecting block is connected to the second fixing column and the fourth fixing column respectively by screws; the sleeve is internally provided with six first convex structures, and a rectangular groove is formed between each two first convex structures for a total of three rectangular grooves, and a second incline is set at a lower end of each of the first convex structures; the sleeve is set on the button, the rotating fastener, and the outer part of the circular column; the upper end of the sleeve is set at the lower end of the button, and the three rectangles corresponding to the three second convex structures, in the six rectangular limiting columns at the lower end of the button respectively; the limiting columns, are one-to-one correspondingly mounted in three rectangular grooves, and the three second convex structures are respectively mounted in three rectangular grooves;
one end of the spring is fixed in the first fixing ring and the second fixing ring of the expansion fastener, and the other end of the spring is fixed on the outer cylinder wall of the sleeve;
the first limiting column and the third limiting column are respectively mounted on opposite sides of one end of the mounting seat, and the fourth limiting column and the sixth limiting column are respectively installed on opposite sides of the other end of the mounting seat, going through the first limiting column, the third limiting column, the fourth limiting column and the sixth limiting column to limit the mounting seat; the fifth limiting columns is mounted on one side of the first fixing block, and the second limiting column is mounted on one side of the second fixing blocking, limiting the first fixing block through the fifth limiting column, and limiting the second fixing block through the second limiting column; and
the first incline of the surfaces of the six first waveform protruding structure surfaces is respectively matched with the three inclines of the three second waveform protruding structure surfaces and the incline of the three third waveform protruding structure surfaces; and the third incline of the upper edge of the second convex structured corresponds to the rectangular limiting column instead of the first incline.

6. The pet traction device according to claim, wherein the rotary fixing component includes a first rotating wheel and a second rotating wheel, and the first rotating wheel and the second rotating wheel are connected by a connecting cylinder, and the wheel disc rim of the first rotating wheel is provided with tooth structures; each of the two tooth structures is provided with a fixing groove, and a lightweight structure is arranged on the wheel disc of the first rotating wheel, and the lightweight structure, outer ring is connected with the inner ring of tooth structures; the lightweight structure inner ring is connected to a fourth fixing ring, and a fifth fixing ring is located on the inner ring of the fourth fixing ring; the fifth fixing ring is fixed on the wheel disc of the first rotating wheel, a sixth fixing ring is located in the inner ring of the fifth fixing ring, and the sixth fixing ring is fixed on the wheel disc of the first rotating wheel; a center ring is located on the inner ring of the sixth fixing ring and the center ring is fixed on the wheel disc of the first rotating wheel, and a fixing hole of the a traction leash is set on the outer ring of the lightweight structure;
the lightweight structure of the first rotating wheel is limited by the second limit ring, and the wheel disc of the first rotating wheel is limited by the first limit ring; the lightweight structure of the second rotating wheel is limited by the third limit ring; and
the center ring of the first rotating wheel is sleeved on the fixed mounting shaft of the second lower casing, while the center ring of the second rotating wheel is set on the center column of the first lower casing, and the fourth fixing ring of the second rotating wheel is mounted on the first fixing ring outer ring; the fifth fixing ring of the second rotating wheel is installed in the annular groove between the first fixing ring and the second fixing ring; and the sixth fixing ring of the second rotating wheel is mounted on the second fixing ring inside annular groove between the third fixing ring.

7. The pet traction device according to claim 6, wherein the traction leash entry and exit mechanism comprises a body a ring structure, wherein an inlet and outlet inclines, a traction leash inlet and outlet; the traction leash inlet and outlet are arranged in the middle of the body; the inlet and outlet inclines are arranged at the inlet and outlet edges of the traction leash; the ring structure is arranged at the outer edge of the body, and the ring structure is installed in the second traction leash exit mechanism mounting groove to complete the connection between the traction leash inlet and outlet mechanism and the casing; and the traction leash entry and exit mechanism is mounted on the traction leash outlet mechanism composed of the first traction leash exit mechanism mounting groove and the second traction leash exit mechanism mounting groove; and
the above traction leash fixing column extends into the traction leash fixing hole of the first rotating wheel and the traction leash fixing hole of the second rotating wheel; the end portion is fixed by bolts, the end of the traction leash is fixed on the traction leash fixing column, and then wrapped around the connecting cylinder; and the other end of the traction leash extends out of the traction leash inlet and outlet of the traction leash entry and exit mechanism.

8. The pet traction device according to claim 6, wherein the first limiting plate and the second limiting plate are both set in an open ring structure, and the first limiting plate and the second limiting plate are oppositely set; and the first limiting plate and the second limiting plate after buckling are installed on the outer ring of the connecting cylinder, and the first limiting plate and the second limiting plate are used for limiting the traction leash.
